(19) United States
(12) Patent Application Publication
(10) Pub. No.: US 2012/0044058 A1
(43) Pub. Date: Feb. 23, 2012

(54) RFID TAG AND COMMUNICATION METHOD

(75) Inventors: Shinichi SHIOTSU, Kawasaki (JP); Hiroyasu SUGANO, Kawasaki (JP); Hideki TANAKA, Kawasaki (JP); Daisuke YAMASHITA, Kawasaki (JP)

(73) Assignee: FUJITSU LIMITED, Kawasaki-shi (JP)

(21) Appl. No.: 13/209,544

(22) Filed: Aug. 15, 2011

(30) Foreign Application Priority Data
Aug. 18, 2010 (JP) 2010-183404

(51) Int. Cl. G06K 7/01

(52) U.S. Cl. 340/10.5

(57) ABSTRACT

An RFID tag that communicates information with an RFID reader/writer includes a receiving unit that receives ID information; a memory unit that stores the ID information; a table that stores a correspondence relation between a change in the ID information and a moving direction; a determining unit that refers to the table to determine a moving direction from ID information received by the receiving unit and previously received ID information stored in the memory unit; and a signal generating unit that sends an interruption signal to a control unit driven by electric power supplied from a battery when the moving direction is determined by the determining unit, and stops generating the interruption signal when the moving direction is not determined by the determining unit.

### CROSS-REFERENCE TO RELATED APPLICATIONS

This application is based upon and claims the benefit of priority of the prior Japanese Patent Application No. 2010-183404, filed on Aug. 18, 2010, the entire contents of which are incorporated herein by reference.

### FIELD

The embodiments discussed herein relate to a radio frequency identification (RFID) tag and an RFID tag communication method.

### BACKGROUND

Conventionally, there exists a system in which a user is made to carry an RFID tag and information is displayed on the RFID tag by transmission between the RFID tag and an RFID reader/writer installed at a specific location such as a gate. Further, there is a system that derives a moving direction of a moving object by attaching two RFID tags to the moving object so that an RFID reader/writer can detect the order of the two RFID tags on the moving object.

### SUMMARY

According to an aspect of the invention, an RFID tag that communicates information with an RFID reader/writer includes a receiving unit that receives ID information; a memory unit that stores the ID information; a table that stores a correspondence relation between a change in the ID information and a moving direction; a determining unit that refers to the table to determine a moving direction from ID information received by the receiving unit and previously received ID information stored in the memory unit; and a signal generating unit that sends an interruption signal to a control unit driven by electric power supplied from a battery when the moving direction is determined by the determining unit, and stops generating the interruption signal when the moving direction is not determined by the determining unit.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an RFID tag according to an embodiment.

FIG. 2 is a block diagram illustrating a system using an RFID tag according to an embodiment.

FIG. 3 is an example of setting table for the system using the RFID tag according to the embodiment.

FIG. 4 is a block diagram illustrating an RFID tag according to the embodiment.

FIG. 5 is an example of a comparison determination table for the RFID tag according to the embodiment.

FIG. 6 is a flow chart illustrating passage detection procedures of an RFID tag according to the embodiment.

FIG. 7 is a flow chart illustrating controller side procedures of an RFID tag according to the embodiment.

FIG. 8 is a timing diagram illustrating operations of a system using the RFID tag according to the embodiment.

FIG. 9 is a block diagram illustrating an RFID tag according to the embodiment.

FIG. 10 is a flow chart illustrating a passage detection procedure of an RFID tag according to the embodiment.

FIG. 11 is a flow chart illustrating controller side procedures of an RFID tag according to the embodiment.

### DESCRIPTION OF EMBODIMENTS

For example, an RFID reader/writer includes multiple antennas and each antenna is provided with unique ID (identifier) information. When an RFID tag approaches the antennas, the unique ID information from the antennas is written in the memory inside the RFID tag. The RFID tag senses its own moving direction according to the order in which the ID information was written. With this configuration, it can be assumed that an RFID tag can determine its own moving direction and independently conduct an operation based on the moving direction.

However, power consumption inside the RFID tag increases due to memory access since, for example, a controller that controls applications and operations of a built-in sensor frequently accesses the memory containing the ID information to read multiple pieces of ID information. When the controller in the RFID tag accesses the memory, the memory is activated by power supplied from a battery built into the RFID tag. Therefore, a problem occurs in that the battery does not last long in a configuration where the frequency of memory access by the abovementioned controller increases. In particular, batteries may last even less time when a memory type that consumes much power such as, for example, a Ferroelectric Random Access Memory (FRAM), is used in the RFID tag.

The embodiments herein seek to reduce power consumption in an RFID tag.

Example embodiments of the RFID tag will be described herein with reference to the accompanying drawings. The RFID tag stores location information sent by the RFID reader/writer, compares the stored location information with newly received location information, and then sends an interruption signal when the moving direction is determined. Accordingly, the interruption signal is not sent when the moving direction is not determined. Power consumption by the circuit that operates the battery can be reduced by not sending the interruption signal. In the following embodiments, the same configuration elements are assigned the same reference numerals, and the description thereof is omitted here.

### EMBODIMENT

Description of RFID Tag

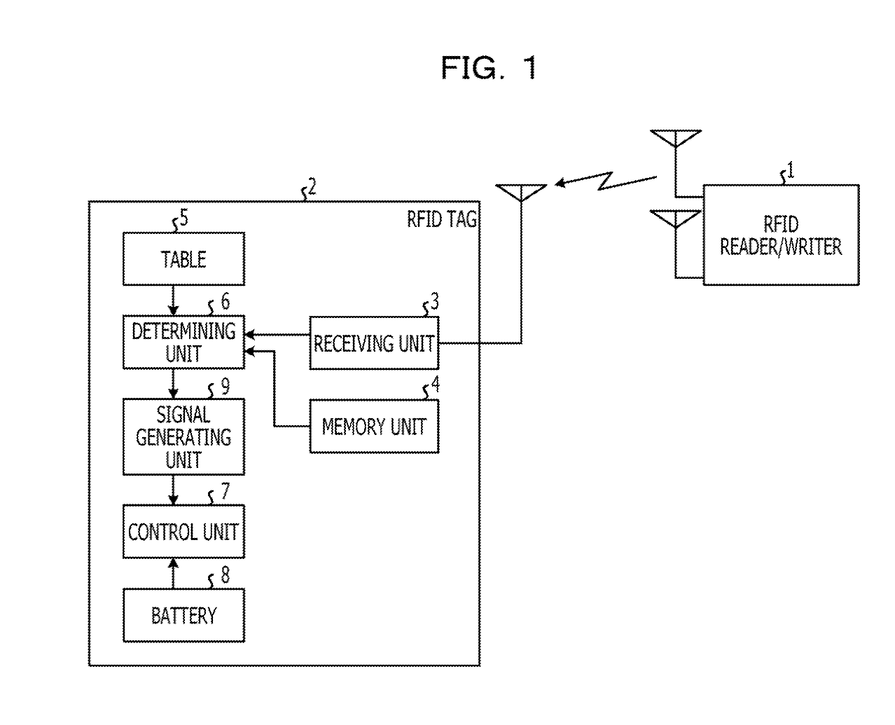

FIG. 1 is a block diagram illustrating an RFID tag according to an embodiment. As illustrated in FIG. 1, an RFID tag 2 communicates information with an RFID reader/writer 1. The RFID tag 2 includes a receiving unit 3, a memory unit 4, a table 5, a determining unit 6, a control unit 7, and a signal generating unit 9. The receiving unit 3 receives location information sent by the RFID reader/writer 1. The memory unit 4 stores the location information. The table 5 stores a correspondence relation between changes in the location information and moving directions. The determining unit 6 refers to the table 5 to determine the moving direction from location information received from the receiving unit 3 and the previously received information location stored in the memory unit 4. The control unit 7 is driven by power supplied from a battery 8 built into the RFID tag 2. The signal generating unit 9 sends an interruption signal to the control unit 7 when the moving direction can be determined by the determining unit 6, and stops the generation of an interruption signal when the moving direction cannot be determined by the determining unit 6.

According to the embodiment, the control unit 7 is driven by the battery 8 and the signal generating unit 9 sends an interruption signal to the control unit 7 when the moving direction of the RFID tag 2 is determined. When the moving direction of the RFID tag 2 cannot be determined, the signal generating unit 9 stops the generation of the interruption signal and hence the operations of the control unit 7 driven by the battery are reduced and consumption of power by the battery is reduced. Power in a battery of a related art RFID tag would be consumed when the moving direction is determined. A related art RFID tag would use power from the battery to conduct multiple memory accesses to read multiple pieces of location information from the memory to determine the moving direction of the RFID tag. Compared to the related art RFID tag, the RFID tag 2 that is applicable to the embodiments offers substantially reduced consumption of battery power. Therefore, the RFID tag 2 provides substantially lower power consumption.

### Other Embodiments

Description of System Using RFID Tags

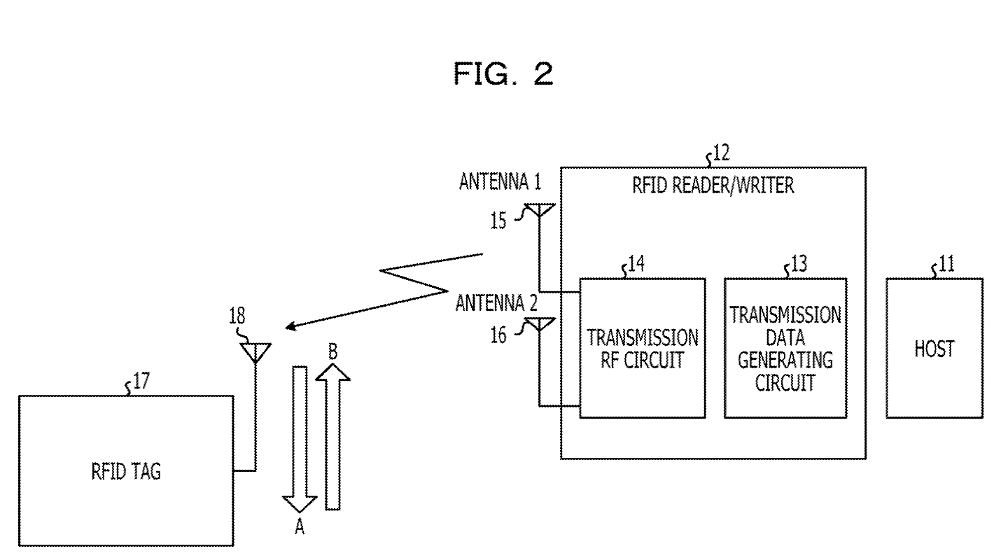

FIG. 2 is a block diagram illustrating a system using an RFID tag according to an embodiment. As illustrated in FIG. 2, a host 11 sets location ID information that uniquely identifies antennas, for example, as location information for each antenna of the RFID reader/writer 12 according to a setting table to be described below. The host 11 sets parameters and commands and the like to send to the RFID tag 17.

The RFID reader/writer 12 is equipped with a transmission data generating circuit 13, a transmission radio frequency (RF) circuit 14, and multiple antennas such as an antenna 1_15 and an antenna 2_16. The transmission data generating circuit 13 generates data to send to the RFID tag 17 based on the location ID information for each antenna, commands, and parameters set by the host 11. The transmission RF circuit 14 conducts encoding and modulation processing on the data generated by the transmission data generating circuit 13, and sends the processed data as transmission signals from the antenna 1_15 and the antenna 2_16. The antenna 1_15 and the antenna 2_16 are arranged away from each other to allow identification by an antenna 18 of the RFID tag 17.

Description of Setting Table

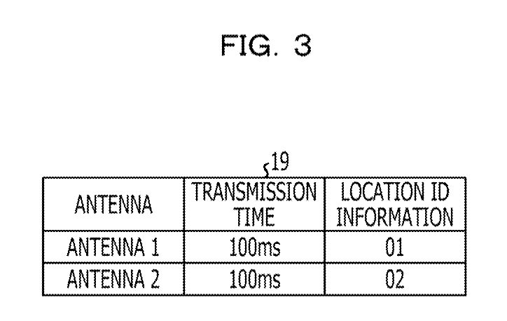

FIG. 3 is an example of setting table for the system using the RFID tag according to the embodiment. As illustrated in FIG. 3, location ID information given to each antenna of the RFID reader/writer 12 and a time period for sending the location ID information from the applicable antennas are set in a setting table 19. In the example illustrated in FIG. 3, “01” is set as location ID information to be sent for a period of 100 ms from, for example, the antenna 1_15. Similarly, “02” is set as location ID information to be sent for a period of 100 ms from, for example, the antenna 2_16.

As illustrated in FIG. 2, when, for example, the location ID information “02” is received after receiving the location ID information “01”, the RFID tag 17 senses that it has passed near the RFID reader/writer 12 in a direction (direction A) from antenna 1_15 toward antenna 2_16. When, for example, the location ID information “01” is received after receiving the location ID information “02”, the RFID tag 17 senses that it has passed near the RFID reader/writer 12 in a direction (direction B) from antenna 2_16 toward antenna 1_15.

Description of RFID Tag

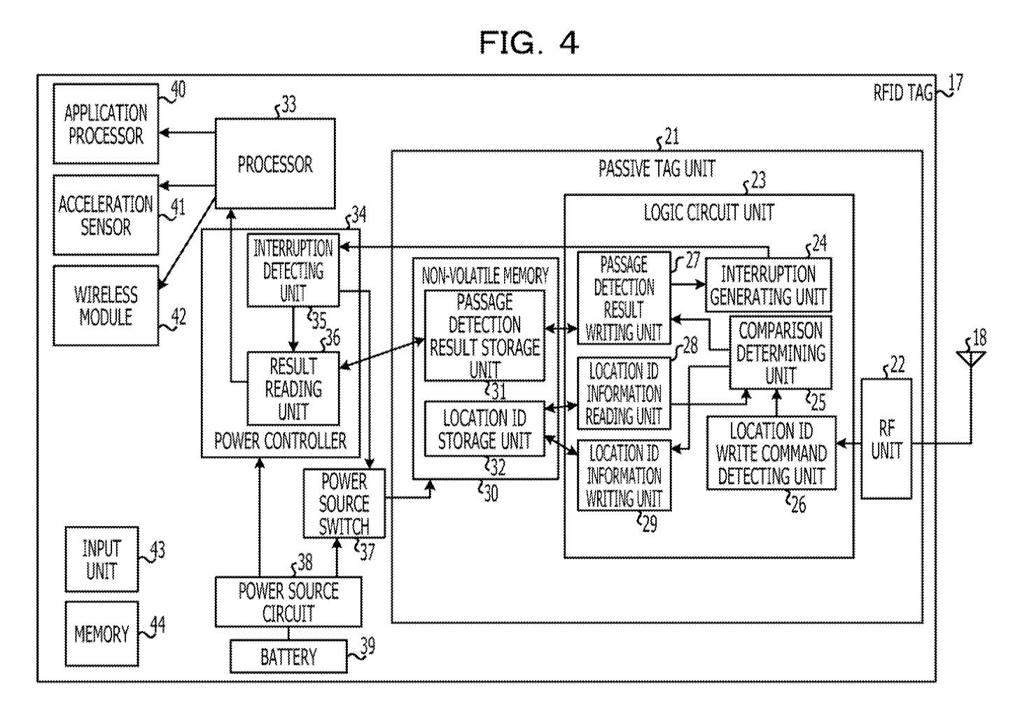

FIG. 4 is a block diagram illustrating an RFID tag according to an embodiment. As illustrated in FIG. 4, the RFID tag 17 includes a passive tag unit 21. The passive tag unit 21 acts as a receiving unit and includes, for example, an RF unit 22, a logic circuit unit 23, and a non-volatile memory 30 built into the passive tag unit 21 as, for example, a memory unit. The RF unit 22 receives signals sent from the RFID reader/writer 12 via the antenna 18. The RF unit 22 conducts demodulation and decoding processing on the received signals and outputs the processed signals as location ID information, commands, and parameters.

The logic circuit unit 23 includes an interruption generating unit 24 that acts as, for example, a signal generating unit. The logic circuit unit 23 includes a comparison determining unit 25 that acts as, for example, a determining unit, and a location ID write command detecting unit 26. The logic circuit unit 23 further includes a passage detection result writing unit 27, a location ID information reading unit 28, and a location ID information writing unit 29. The logic circuit unit 23 includes some notification unit functions. The notification unit records a moving direction in a passage detection result storage unit 31 for notifying the moving direction to other functions. The moving direction is notified when a moving direction obtaining command is received from the RFID reader/writer 12 by recording the moving direction in the passage detection result storage unit 31.

The location ID write command detecting unit 26 detects a location ID write command from the data outputted by the RF unit 22 and transfers the command to the comparison determining unit 25 as current location ID information. The comparison determining unit 25 reads previous location ID information stored in a location ID storage unit 32 in the non-volatile memory 30 via the location ID information reading unit 28. The comparison determining unit 25 compares the current location ID information with the previous location ID information and refers to a table such as, for example, a comparison determination table described below to determine the moving direction of the RFID tag 17. The comparison determination table stores changes in the location ID information and the moving direction of the RFID tag 17 in association with each other. The comparison determining unit 25 transfers the moving direction comparison result to the passage detection result writing unit 27.

The passage detection result writing unit 27 transfers the moving direction comparison result to the passage detection result storage unit 31 in the non-volatile memory 30. The passage detection result writing unit 27 outputs an interruption request signal to the interruption generating unit 24 based on the moving direction comparison result. The interruption generating unit 24 receives the interruption request signal and sends an interruption signal to an interruption detecting unit 35 of a power controller 34 to be described below. The location ID information reading unit 28 reads the previous location ID information from the location ID storage unit 32 and transfers the previous location ID information to the comparison determining unit 25. The comparison determining unit 25 transfers the current location ID information to the location ID information writing unit 29. The location ID information writing unit 29 writes the current location ID information into the location ID storage unit 32 as previous location ID information.

Moreover, the logic circuit unit 23 includes a power regenerating circuit (not illustrated). The power regenerating circuit converts radio waves received from the antenna 18 to electric power. The units in the passive tag unit 21 operate using the electric power supplied by the power regenerating circuit.

The non-volatile memory 30 includes the passage detection result storage unit 31 that acts as, for example, a storage unit, and the location ID storage unit 32 that acts as, for example, a storage unit in a memory unit. The passage detection result storage unit 31 stores a comparison result of the moving direction written by the passage detection result writing unit 27. The location ID storage unit 32 stores the current location ID information and the previous location ID information written by the location ID information writing unit 29. The non-volatile memory 30 is equipped with, for example, a dual port memory that can be accessed by both the logic circuit unit 23 and the power controller 34 to be described below. The non-volatile memory 30 may be, for example, a ferroelectric memory.

Moreover, the RFID tag 17 includes an active portion that is enabled by a built-in power source. The active portion includes a processor 33, a power controller 34, a power source switch 37, a power source circuit 38, a battery 39, an application processor 40, a sensor such as, for example, an acceleration sensor 41, a Wi-Fi or other type of wireless module 42, an input unit 43, and a memory 44. The power controller 34 controls applications and devices such as power sources, sensors, and modules according to the moving direction determination result of the RFID tag 17. The power controller 34 is driven by power supplied from the battery 39 via the power source circuit 38. The power controller 34 is equipped with the interruption detecting unit 35 that acts as, for example, a portion of the notification unit, and a result reading unit 36 that acts as, for example, a portion of the notification unit.

When an interruption signal from the interruption generating unit 24 is detected, the interruption detecting unit 35 notifies the result reading unit 36 that an interruption has been detected. When the notification from the interruption detecting unit 35 is received, the result reading unit 36 reads the moving direction determination result of the RFID tag 17 from the passage detection result storage unit 31 and transfers information that indicates whether the RFID tag 17 passed and in which direction it passed, to the processor 33.

Further, the interruption detecting unit 35 detects the interruption signal from the interruption generating unit 24 and then outputs a switch signal to the power source switch 37. The power source switch 37 supplies power from the battery 39 to the non-volatile memory 30 via the power source circuit 38 based on the input of the switch signal. That is, power is supplied to the non-volatile memory 30 from the power regenerating circuit as described above when the logic circuit unit 23 accesses the non-volatile memory 30, and power is supplied to the non-volatile memory 30 from the battery 39 when the power controller 34 accesses the non-volatile memory 30.

The processor 33 controls, for example, the application processor 40, the acceleration sensor 41, or the wireless module 42 based on the information that indicates whether the RFID tag 17 passed through and the moving direction when the RFID tag 17 passed through. For example, the processor 33 instructs the application processor 40 to conduct operations such as activating or stopping applications. For example, the processor 33 turns the power of the acceleration sensor 41 and the wireless module 42 on or off. Contents of the control operations by the processor 33 are prescribed in, for example, a control table.

For example, controlling the acceleration sensor 41, the application processor 40, and the wireless module 42 when the moving direction of the RFID tag 17 is the direction A (see FIG. 2) may be prescribed in the control table. That is, when the previous location ID information is “01” and the current location ID information is “02”, controls such as turning the power of the acceleration sensor 41 on, activating an application by the application processor 40, and turning the power of the wireless module 42 off may be prescribed in the control table. For example, controlling the acceleration sensor 41, the application processor 40, and the wireless module 42 when the moving direction of the RFID tag 17 is the direction B (see FIG. 2) may also be prescribed in the control table. That is, when the previous location ID information is “02” and the current location ID information is “01”, controls such as turning the power of the acceleration sensor 41 off, turning the power of the wireless module 42 on, and terminating an application by the application processor 40 may be prescribed in the control table.

The input unit 43 may be, for example, a key, a button, a switch, or a touch panel. The memory 44 may store an operating system (OS) and an application program executed by the processor 33, and may be used as a work region of the OS and the application program. A mobile phone equipped with an RFID tag is an example of the RFID tag 17.

Description of Comparison Determination Table

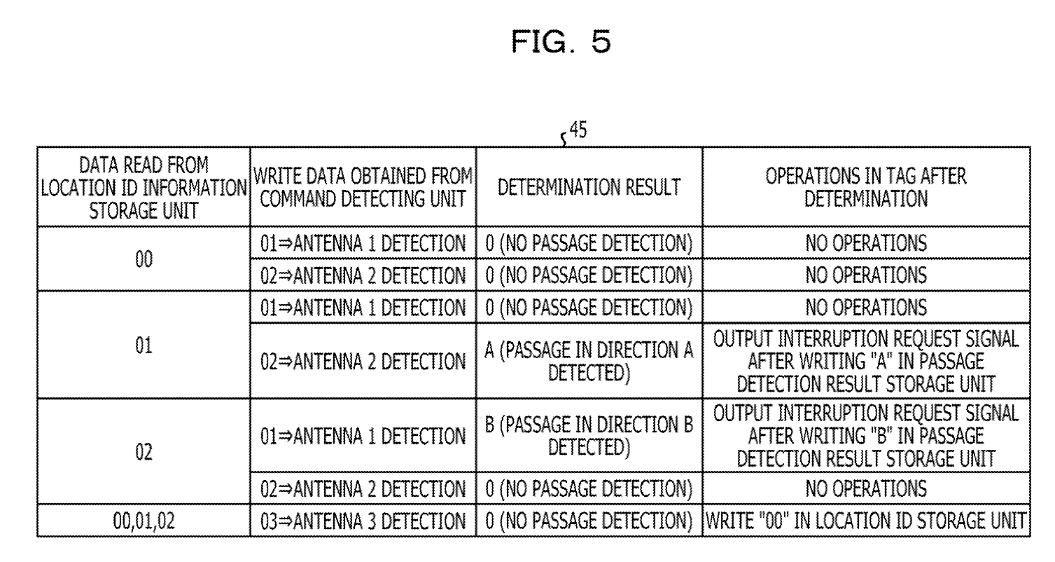

FIG. 5 is an example of a comparison determination table for the RFID tag according to the embodiment. As illustrated in FIG. 5, a determination result of the moving direction of the RFID tag based on a combination of the previous location ID information and the current location ID information, and operations inside the RFID tag 17 to be conducted after the determination are prescribed in a comparison determination table 45. The previous location ID information is read from the location ID storage unit 32. The current location ID information is obtained from the location ID write command detecting unit 26.

For example, the combination of the previous location ID information and the current location ID information is represented as “previous location ID information, current location ID information.” Moreover, the location ID information of a third antenna other than antenna 1_15 or antenna 2_16 is “03.” The third antenna is not used to detect the moving direction of the RFID tag 17. For example, when combinations of the location ID information are represented as [00,01], [00,02], [01,01], [02,02], [00,03], [01,03], and [02,03], the determination result of the moving direction of the RFID tag 17 is “0” which indicates no passage detection. When, for example, combinations of the location ID information are represented as [00,01], [00,02], [01,01], and [02,02], no operations are conducted in the RFID tag 17 after the determination. When, for example, combinations of the location ID information are represented as [00,03], [01,03], and [02,03], writing “00” as the previous location ID information in the location ID storage unit 32 becomes the operation in the RFID tag 17 after the determination.

When the combination is [01,02] for example, the determination result of the moving direction of the RFID tag 17 is “A” which indicates that the RFID tag 17 moved in the direction A. After the determination, writing “A” in the passage detection result storage unit 31 and outputting an interruption request signal from the passage detection result writing unit 27 to the interruption generating unit 24 are conducted as operations in the RFID tag 17. When the combination is [02,01] for example, the determination result of the moving direction of the RFID tag 17 is “B” which indicates that the RFID tag 17 moved in the direction B. After the determination, writing “B” in the passage detection result storage unit 31 and outputting an interruption request signal from the passage detection result writing unit 27 to the interruption generating unit 24 are conducted as operations in the RFID tag 17.

Description of Passage Detection Processing

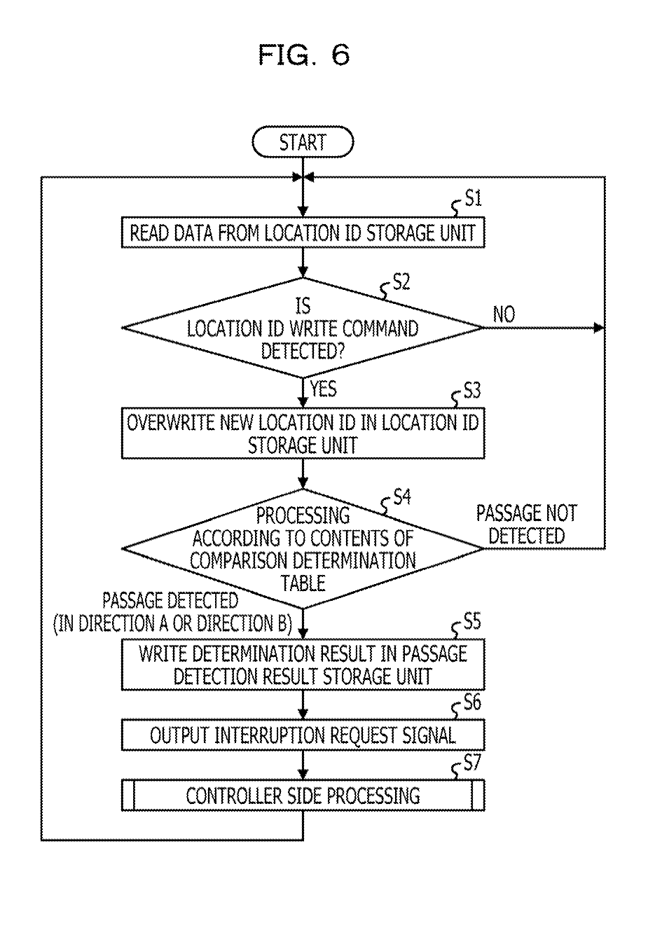

FIG. 6 is a flow chart illustrating passage detection procedures of an RFID tag according to the present embodiment. As illustrated in FIG. 6, when the passage detection processing is started in the RFID tag 17, the location ID information reading unit 28 first conducts processing (step S1), and then the location ID write command detecting unit 26 conducts processing (step S2). Until the location ID write command detecting unit 26 detects a location ID write command (step S2: No), the location ID information reading unit 28 reads data (location ID information) from the location ID storage unit 32 and sends the data to the comparison determining unit 25 (step S1).

When the location ID write command detecting unit 26 detects a location ID write command (step S2: Yes), the comparison determining unit 25 and the location ID information writing unit 29 conduct processing (step S3). The comparison determining unit 25 receives new location ID information (current location ID information) included in the location ID write command from the location ID write command detecting unit 26, and sends the new location ID information to the location ID information writing unit 29. The location ID information writing unit 29 overwrites the new location ID information received from the comparison determining unit 25 in the location ID storage unit 32 (step S3).

Next, the comparison determining unit 25 compares the previous location ID information and the current location ID information and refers to the comparison determination table 45 to determine the moving direction of the RFID tag 17 (step S4). When the result of the determination indicates that the RFID tag 17 moved in the direction A or the direction B (step S4: passage detected), the comparison determining unit 25 sends the determination result to the passage detection result writing unit 27. The passage detection result writing unit 27 writes the determination result into the passage detection result storage unit 31 (step S5).

Furthermore, the passage detection result writing unit 27 outputs an interruption request signal to the interruption generating unit 24 (step S6). As a result, the interruption generating unit 24 outputs an interruption signal to the interruption detecting unit 35. Next, processing by the power controller 34 is conducted (step S7). Then the RFID tag 17 processing returns to step S1 to repeat the steps from step S1 to step S7. On the other hand, when the result of the determination of the moving direction of the RFID tag 17 does not indicate that the RFID tag 17 passed through (step S4: passage not detected), the processing returns to step S1.

Description of Controller Side Processing

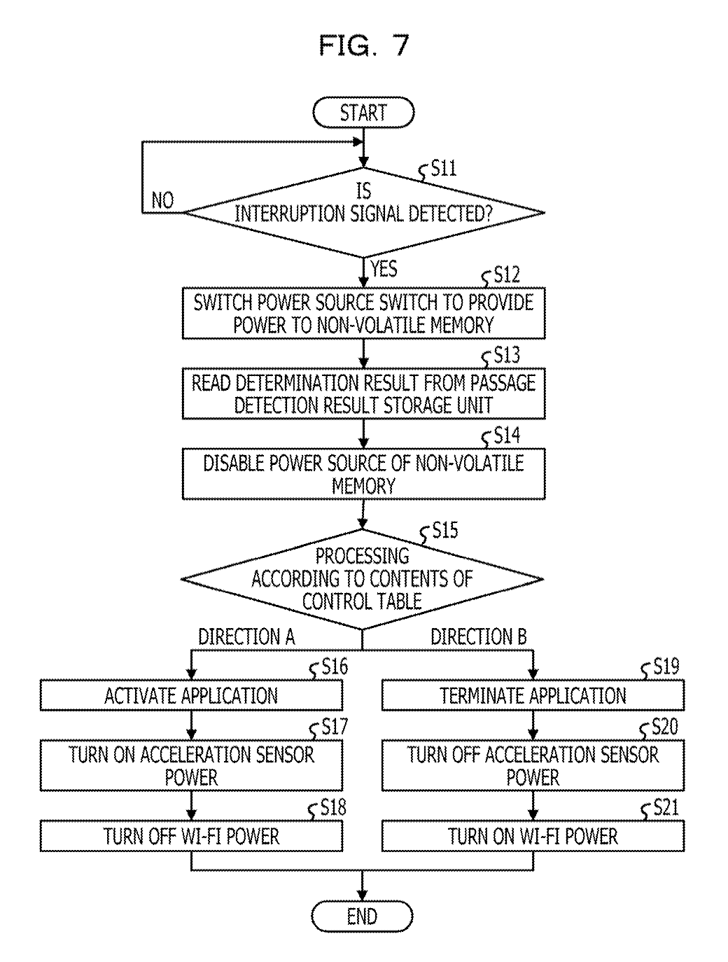

FIG. 7 is a flow chart illustrating controller side procedures of an RFID tag according to an embodiment. As illustrated in FIG. 7, on the power controller 34 side of the RFID tag 17, the power controller 34 waits in a sleep state until the interruption detecting unit 35 detects an interruption signal (step S11: No). When the interruption detecting unit 35 detects an interruption signal (step S11: Yes), a switch signal is outputted to the power source switch 37. As a result, the power source switch 37 is switched so that the power source circuit 38 supplies power to the non-volatile memory 30 from the battery 39 (step S12).

Next, the result reading unit 36 reads the determination result of the moving direction of the RFID tag 17 from the passage detection result storage unit 31 (step S13). When the reading of the determination result from the passage detection result storage unit 31 is completed, the power supply from the battery 39 to the non-volatile memory 30 is terminated. That is, the power supply to the non-volatile memory 30 is disabled (step S14). Next, the processor 33 receives information indicating whether the RFID tag 17 passed through and indicating the moving direction from the result reading unit 36, and conducts processing according to the contents of the control table (step S15).

For example, if the moving direction of the RFID tag is direction A (step S15: direction A), the processor 33 controls the application processor 40, the acceleration sensor 41, and the wireless module (Wi-Fi) 42. The processor 33 activates applications to be conducted by the application processor 40 (step S16). The processor 33 turns the power of the acceleration sensor 41 on (step S17) and turns the power of the wireless module (Wi-Fi) 42 off (step S18). On the other hand, if, for example, the moving direction of the RFID tag 17 is direction B (step S15: direction B), the processor 33 controls the application processor 40, the acceleration sensor 41, and the wireless module (Wi-Fi) 42. The processor 33 terminates applications to be conducted by the application processor 40 (step S19). The processor 33 turns the power of the acceleration sensor 41 off (step S20) and turns the power of the wireless module (Wi-Fi) 42 on (step S21). Then the power controller 34 side processing of the RFID tag 17 is completed.

Description of System Using RFID Tags

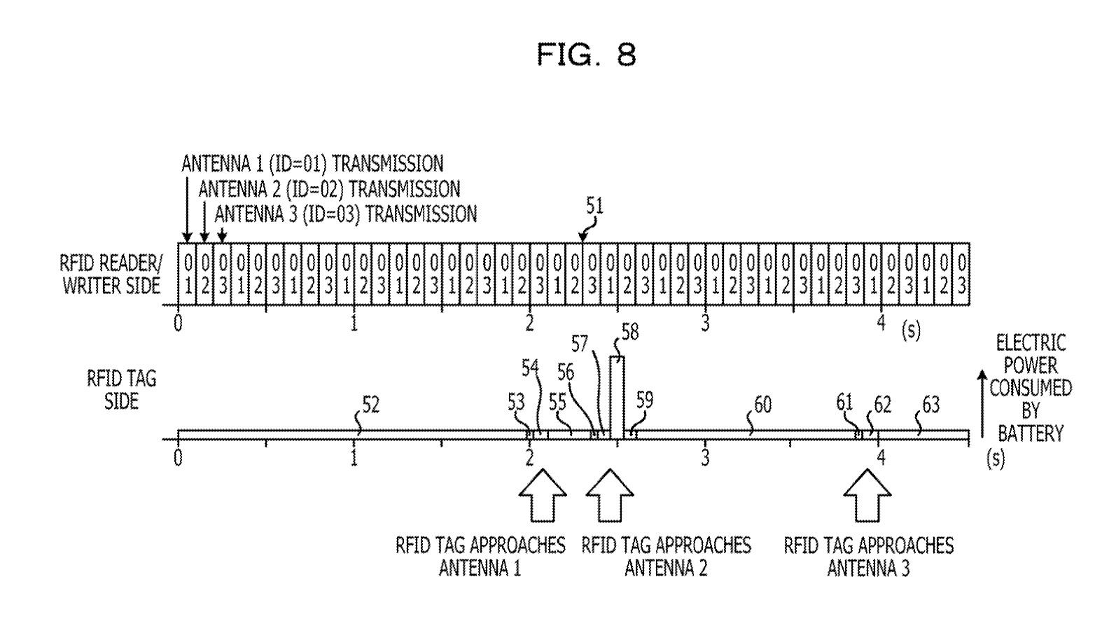

FIG. 8 is a timing diagram illustrating operations of a system using the RFID tag according to the embodiment. As indicated by reference numeral 51, the RFID reader/writer 12 continuously sends location ID information from each of the antennas while switching between the antenna 1_15, the antenna 2_16, and the third antenna (not shown) using time divisions based on, for example, a setting table 19. The RFID reader/writer 12 represents the side transmitting the location ID information.

As indicated by reference numeral 52, the RFID tag 17, in other words the location ID information receiving side, is in an interruption waiting state, in other words a sleep state, until the RFID tag 17 approaches, for example, the antenna 1_15. The electric power consumed by the battery is low during the sleep state. When the RFID tag 17 approaches, for example, the antenna 1_15, the RFID tag 17 receives a location ID interruption command from the antenna 1_15 as indicated by the reference numeral 53. Next, the RFID tag 17 determines whether passage was detected based on the previous location ID information, the current location ID information, and the comparison determination table 45 as indicated by reference numeral 54. The RFID tag 17 determines that passage was not detected based on the previous location ID information (in this case “00”) stored in the location ID storage unit 32, the current location ID information (in this case “01”) from the location ID write command, and the comparison determination table 45. Therefore, the portion that consumes power of the battery 39 in the RFID tag 17 does not conduct any operations. Further, the RFID tag 17 writes “01” in the location ID storage unit 32. The RFID tag 17 then returns to the sleep state as indicated by the reference numeral 55.

When the RFID tag 17 in the sleep state approaches, for example, the antenna 2_16, the RFID tag 17 receives a location ID write command sent from the antenna 2_16 as indicated by the reference numeral 56. Next, the RFID tag 17 determines whether passage was detected based on the previous location ID information, the current location ID information, and the comparison determination table 45 as indicated by reference numeral 57. The RFID tag 17 determines that passage was detected based on the previous location ID information (in this case “01”) stored in the location ID storage unit 32, the current location ID information (in this case “02”) from the location ID write command, and the comparison determination table 45. Power is supplied from the battery 39 to the non-volatile memory 30 as indicated by the reference numeral 58. In this state, the result reading unit 36 reads the determination result of the moving direction of the RFID tag 17 from the passage detection result storage unit 31 and notifies the processor 33. Next, the power for the non-volatile memory 30 is disabled as indicated by the reference numeral 59 and the processor 33 conducts processing according to the control table. Further, the RFID tag 17 writes “02” in the location ID storage unit 32. The RFID tag 17 then returns to the sleep state as indicated by the reference numeral 60.

When the RFID tag 17 in the sleep state approaches, for example, the third antenna, the RFID tag 17 receives a location ID write command sent from the third antenna as indicated by the reference numeral 61. Next, the RFID tag 17 determines whether passage was detected based on the previous location ID information, the current location ID information, and the comparison determination table 45 as indicated by reference numeral 62. The RFID tag 17 determines that passage was not detected based on the previous location ID information (in this case “02”) stored in the location ID storage unit 32, the current location ID information (in this case “03”) from the location ID write command, and the comparison determination table 45. Further, the RFID tag 17 writes “00” in the location ID storage unit 32. The RFID tag 17 then returns to the sleep state as indicated by the reference numeral 63.

According to the embodiment, the determination of the moving direction of the RFID tag 17 is conducted in the passive tag unit 21 using electric power converted from radio waves received via the antenna 18. As a result, if the determination result is not notified to the power controller 34 side, electric power of the battery 39 is not consumed. If the determination result is read by the power controller 34 side, electric power of the battery 39 is consumed. Therefore, a related art RFID tag would use battery power to conduct multiple memory accesses, for example two memory accesses, on the passive memory to read, for example, two pieces of location ID information to determine the moving direction of the RFID tag 17. Compared to the related art RFID tag, the RFID tag 17 that is applicable to the embodiments offers reduced consumption of battery power. Essentially, the RFID tag 17 achieves a substantial reduction in power consumption.

### Other Embodiments

Description of RFID Tag

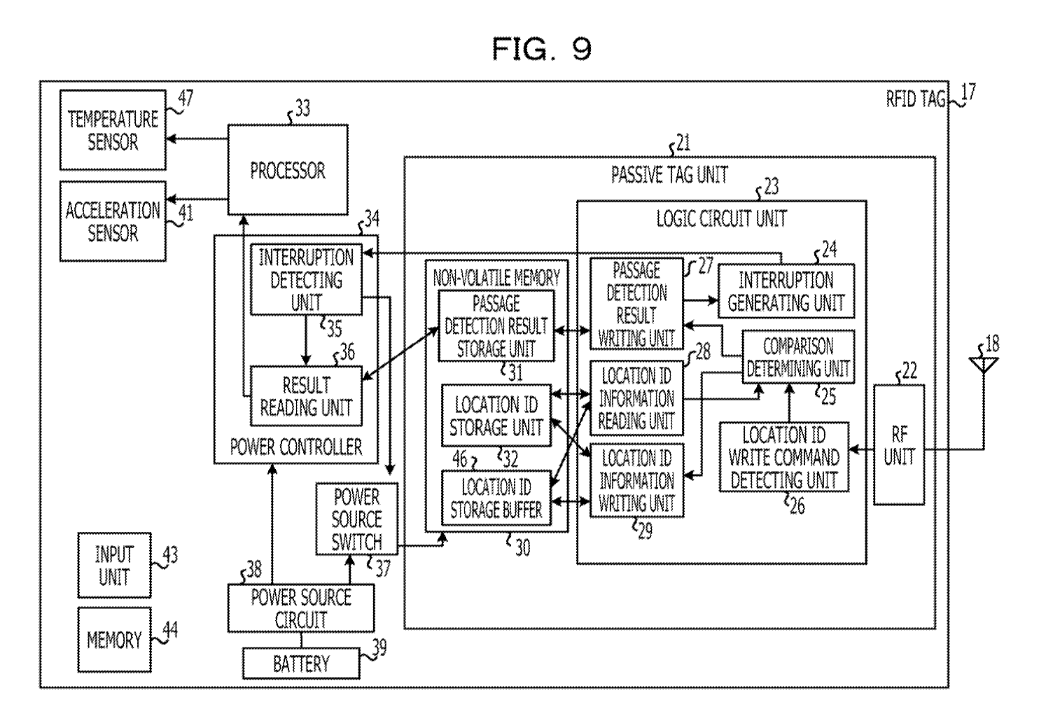

FIG. 9 is a block diagram illustrating an RFID tag according to an embodiment. As illustrated in FIG. 9, the difference between the RFID tag of the present embodiment and the RFID tag according to the embodiment illustrated in FIG. 4 is that the RFID tag of the present embodiment stores the new location ID information obtained when receiving the location ID write command in a memory such as a buffer immediately after receiving the location ID write command. The RFID tag 17 includes, for example, a location ID storage buffer 46 as a buffer in the non-volatile memory 30.

The location ID write command detecting unit 26 transfers the new location ID information to the location ID information writing unit 29. The location ID information writing unit 29 writes the new location ID information in the location ID storage buffer 46. The location ID information reading unit 28 reads the new location ID information from the location ID storage buffer 46 and transfers the new location ID information as current location ID information to the comparison determining unit 25. Other configurations of the passive tag unit 21 are substantially the same as the previous embodiment.

Moreover, the present embodiment is provided with, for example, the acceleration sensor 41 and a temperature sensor 47 as sensors controlled by the processor 33. Moreover, for example, the application processor 40 and the wireless module 42 are not provided in the present embodiment. According to this configuration, when, for example, the moving direction of the RFID tag 17 is direction A (see FIG. 2), turning power to the temperature sensor 47 on and turning the power to the acceleration sensor 41 off may be prescribed in the control table. Moreover, when, for example, the moving direction of the RFID tag 17 is direction B (see FIG. 2), turning power to the temperature sensor 47 off and turning the power to the acceleration sensor 41 on may be prescribed in the control table.

Description of Passage Detection Processing

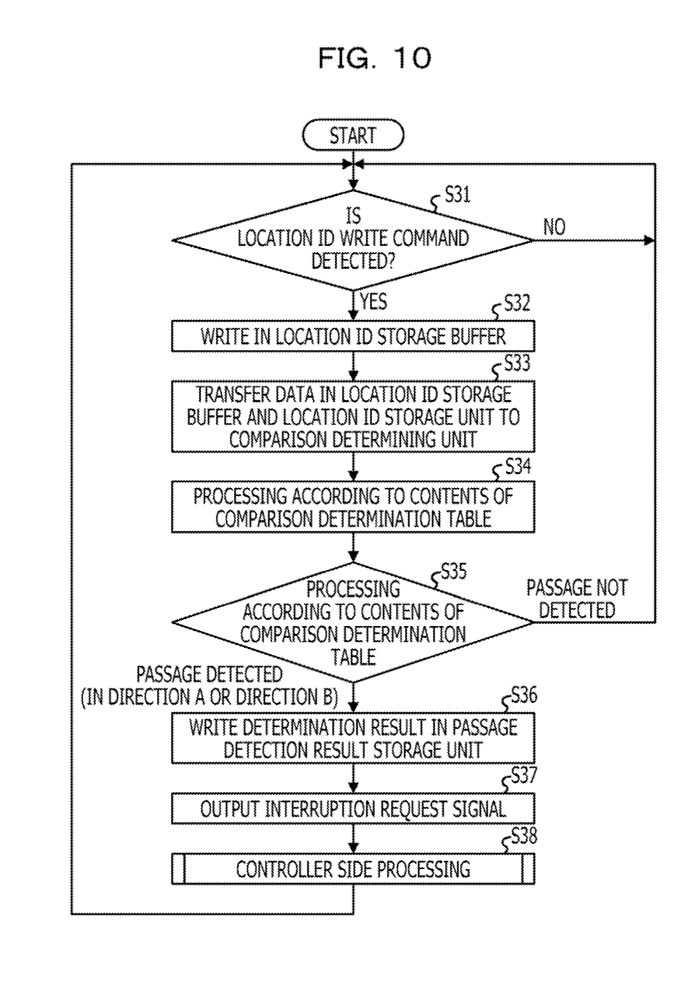

FIG. 10 is a flow chart illustrating a passage detection procedure of an RFID tag according to the present embodiment. As illustrated in FIG. 10, when the passage detection processing is started in the RFID tag 17, first the location ID information writing unit 29 is idle until the location ID write command detecting unit 26 detects the location ID write command (step S31: No). When the location ID write command detecting unit 26 detects a location ID write command (step S31: Yes), the location ID write command detecting unit 26 transfers new location ID information included in the location ID write command to the location ID information writing unit 29. The location ID information writing unit 29 writes the new location ID information received from the location ID write command detecting unit 26 in the location ID storage buffer 46 (step S32).

Next, the location ID information reading unit 28 reads the data from the location ID storage buffer 46 and transfers the data as current location ID information to the comparison determining unit 25. The location ID information reading unit 28 reads the data from the location ID storage unit 32 and transfers the data as the previous location ID information to the comparison determining unit 25 (step S33). Next, the comparison determining unit 25 transfers the current location ID information to the location ID information writing unit 29. The location ID information writing unit 29 writes the current location ID information received from the comparison determining unit 25 in the location ID storage unit 32 (step S34).

Subsequent processing is substantially similar to the processing from step S4 to step S7 in the flow chart illustrated in FIG. 6 (step S35 to step S38).

Description of Controller Side Processing

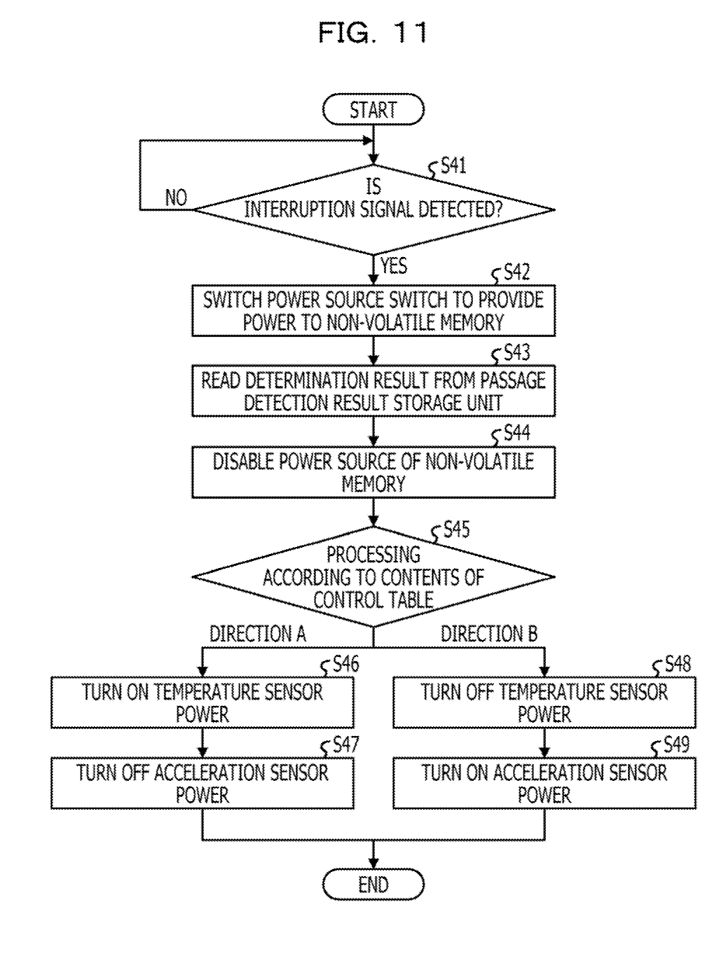

FIG. 11 is a flow chart illustrating example controller side procedures of an RFID tag according to the embodiment. As illustrated in FIG. 11, when the processing of the power controller 34 side of the RFID tag 17 starts, first processing substantially similar to step S11 to step S15 of the flowchart illustrated in FIG. 7 of the previous embodiment are conducted (step S41 to step S45). If the moving direction of the RFID tag 17 is, for example, direction A (step S45: direction A), the processor 33 turns the power to the temperature sensor 47 on (step S46), and turns the power to the acceleration sensor 41 off (step S47). On the other hand, if the moving direction of the RFID tag 17 is, for example, direction B (step S45: direction B), the processor 33 turns the power to the temperature sensor 47 off (step S48), and turns the power to the acceleration sensor 41 on (step S49). Then the power controller 34 side processing of the RFID tag 17 is completed.

Description of Operation of System Using RFID Tags

A timing diagram illustrating operations of a system using the RFID tag according to the present embodiment is substantially similar to the diagram illustrated in FIG. 8. However, differences between the present embodiment and the previous embodiment are described below.

At the timing indicated by reference numeral 53 in FIG. 8, the RFID tag stores location ID information “01” of the antenna 1_15 in the location ID storage buffer 46 when the location ID write command is received from the antenna 1_15. Next, the RFID tag 17 determines whether passage was detected based on the previous location ID information, the current location ID information, and the comparison determination table 45 as indicated by reference numeral 54 in FIG. 8. The RFID tag 17 determines that passage was not detected based on the previous location ID information (in this case “00”) stored in the location ID storage unit 32, the current location ID information (in this case “01”) stored in the location ID storage buffer 46, and the comparison determination table 45. Moreover, the RFID tag 17 writes the location ID information (in this case “01”) stored in the location ID storage buffer 46 into the location ID storage unit 32.

At the timing indicated by reference numeral 56 in FIG. 8, the RFID tag stores location ID information “02” of the antenna 2_16 in the location ID storage buffer 46 when the location ID write command is received from the antenna 2_16. Next, the RFID tag 17 determines whether passage was detected based on the previous location ID information, the current location ID information, and the comparison determination table 45 as indicated by reference numeral 57 in FIG. 8. The RFID tag 17 determines that passage was detected based on the previous location ID information (in this case “01”) stored in the location ID storage unit 32, the current location ID information (in this case “02”) stored in the location ID storage buffer 46, and the comparison determination table 45. Moreover, the RFID tag 17 writes the location ID information (in this case “02”) stored in the location ID storage buffer 46 into the location ID storage unit 32.

At the timing indicated by reference numeral 61 in FIG. 8, the RFID tag 17 stores location ID information “03” of the third antenna in the location ID storage buffer 46 when the location ID write command is received from the third antenna. Next, the RFID tag 17 determines whether passage was detected based on the previous location ID information, the current location ID information, and the comparison determination table 45 as indicated by reference numeral 62 in FIG. 8. The RFID tag 17 determines that passage was not detected based on the previous location ID information (in this case “02”) stored in the location ID storage unit 32, the current location ID information (in this case “03”) stored in the location ID storage buffer 46, and the comparison determination table 45. Further, the RFID tag 17 writes “00” into the location ID storage unit 32.

Results similar to the previous embodiment are achieved with the present embodiment. Moreover, immediately after receiving the location ID write command, the RFID tag 17 stores the received location ID information in the location ID storage buffer 46 thus substantially reducing or preventing the loss of the new location ID information during the determination of the moving direction of the RFID tag 17 even when the state of communication is poor.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. An RFID tag that communicates information with an RFID reader/writer, the RFID tag comprising:
a receiving unit that receives ID information;
a memory unit that stores the ID information;
a table that stores a correspondence relation between a change in the ID information and a moving direction;
a determining unit that refers to the table to determine a moving direction from ID information received by the receiving unit and previously received ID information stored in the memory unit; and
a signal generating unit that sends an interruption signal to a control unit driven by electric power supplied from a battery when the moving direction is determined by the determining unit, and stops generating the interruption signal when the moving direction is not determined by the determining unit.

2. The RFID tag according to claim 1, further comprising:
a notification unit that records the moving direction in a storage unit and sends the recorded moving direction to the control unit when the moving direction is determined.

3. The RFID tag according to claim 2, wherein the control unit controls an activation of an application that operates with electric power supplied by the battery according to the recorded moving direction.

4. The RFID tag according to claim 2, wherein the control unit controls powering on and powering off of a built-in device according to the recorded moving direction.

5. The RFID tag according to claim 1, wherein the memory unit includes a storage unit that stores previously received ID information, and a buffer that stores currently received ID information.

6. The RFID tag according to claim 2, wherein the receiving unit, the determining unit, and the memory unit are driven by electric power obtained by converting radio waves that are received.

7. The RFID tag according to claim 6, wherein the memory unit is a non-volatile memory unit and reading and writing of the memory unit is driven by electric power obtained by converting radio waves that are received.

8. The RFID tag according to claim 2, further comprising:
a reading unit that reads the recorded moving direction to obtain the moving direction, wherein the recorded moving direction is based on an interruption signal generated by the signal generating unit.

9. The RFID tag according to claim 7, wherein the reading and writing of the non-volatile memory unit is conducted by electric power supplied by the battery when a reading unit reads the recorded moving direction.

10. The RFID tag according to claim 4, wherein the built-in device is a sensor operated by electric power supplied by the battery.

11. The RFID tag according to claim 4, wherein the built-in device is a wireless module operated by electric power supplied by the battery.

12. The RFID tag according to claim 1, wherein moving direction information stored in the table is an ID that represents an operation defined according to a moving direction.

13. The RFID tag according to claim 2, wherein moving direction information recorded in the storage unit is an ID that represents an operation defined according to a moving direction.

14. The RFID tag according to claim 8, wherein moving direction information read from the storage unit by the reading unit is an ID that represents an operation defined according to a moving direction.

15. The RFID tag according to claim 14, wherein the ID that represents the operation is an ID that causes activation of an application operated by electric power supplied by the battery.

16. The RFID tag according to claim 14, wherein the ID that represents the operation is an ID that controls electric power of a sensor operated by electric power supplied by the battery.

17. The RFID tag according to claim 14, wherein the ID that represents the operation is an ID that controls electric power of a wireless module operated by electric power supplied by the battery.

18. The RFID tag according to claim 1, wherein when the moving direction is determined, the moving direction is recorded in the storage unit, and when the moving direction obtaining command is sent by the RFID tag, the recorded moving direction is transmitted.

19. An RFID tag communicating method for communicating information with an RFID reader/writer, the RFID tag communicating method comprising:
receiving, by a receiving unit, ID information;
storing, in a memory unit, the ID information;
storing, in a table, a correspondence relation between a change in the ID information and a moving direction;
referring, by a determining unit, to the table to determine a moving direction from ID information received by the receiving unit and previously received ID information stored in the memory unit; and
sending, by a signal generating unit, an interruption signal to a control unit driven by electric power supplied from a battery when the moving direction is determined by the determining unit, and stops generating the interruption signal when the moving direction is not determined by the determining unit.

20. The RFID tag communicating method according to claim 19, further comprising:
recording, by a notification unit, the moving direction in a storage unit and sending the recorded moving direction to the control unit when the moving direction is determined.
